(19) United States
(12) Patent Application Publication
(10) Pub. No.: US 2017/0130098 A1
(43) Pub. Date: May 11, 2017

(54) SEALING WEB ACTIVATABLE WITHOUT OPEN FLAME AND HAVING A HOT-MELT ADHESIVE COATING, AND METHOD FOR APPLYING SAID SEALING WEB

(71) Applicant: SIKA TECHNOLOGY AG, Baar (CH)

(72) Inventor: Matthias GOESSI, Uster (CH)

(73) Assignee: SIKA TECHNOLOGY AG, Baar (CH)

(21) Appl. No.: 15/322,646

(22) PCT Filed: Aug. 28, 2015
(86) PCT No.: PCT/EP2015/069729

§ 371 Date: Dec. 28, 2016

(30) Foreign Application Priority Data
Aug. 28, 2014 (EP) 14182608.1

(51) Int. Cl. C09J 7/02; C09J 9/02; C09J 5/06; B32B 5/02; B32B 7/12; B32B 37/14; B32B 15/08; B32B 15/18; B32B 27/12; B32B 27/30; B32B 27/32; B32B 37/12; C09J 123/08; B32B 15/02

(52) U.S. Cl. CPC C09J 7/0203; C09J 7/0271; C09J 7/0278; C09J 123/0853; C09J 9/02; C09J 5/06; B32B 5/028; B32B 7/12; B32B 15/02; B32B 15/08; B32B 15/18; B32B 27/12; B32B 27/304; B32B 27/32; B32B 37/12; B32B 37/14; C09J 2423/00; C09J 2423/006; C09J 2427/006; B32B 2260/021; B32B 2262/106; B32B 2307/202; B32B 2419/06

(57) ABSTRACT

Composite films include a water-impermeable substrate layer composed of plastic having a coating. In such composite films, the hot-melt adhesive can also be activated in a contactless manner from the side of the composite film opposite the hot-melt adhesive layer. In the application of roof membranes, this leads to the advantage that the membrane no longer has to be moved after the activation of the hot-melt adhesive and can be laid in final positions of the membrane even before the activation of the hot-melt adhesive. In addition, by such composite films, the need to activate the hot-melt adhesive by open flames is avoided and thus the hazard potential of the processing is significantly reduced. Further, a method applies corresponding composite films to a substrate wherein the hot-melt adhesive layer is activated and melted by an inductor.

### TECHNICAL FIELD

The present invention relates to composite films comprising a water-impermeable substrate layer composed of plastic with a coating composed of a flat element composed of an electrically conductive material and a hotmelt adhesive, to a method of applying such composite films to a substrate while heating the hotmelt adhesive with the aid of an alternating magnetic field, and to the use of alternating magnetic fields for activating hotmelt adhesives and bonding of composite films as described above to a substrate.

### BACKGROUND OF THE INVENTION

Roofing membranes nowadays are either laid loose and weighted down, mechanically fixed at individual points, inductively bonded at individual points or bonded over the full area. For bonding of a membrane over the full area, for example on a roof, a cut and cover tunnel or a tunnel lining, it is necessary that the membrane be coated over its full area with an adhesive, which can be applied by on-site personnel during or prior to the bonding, or may already have been applied at the factory to one side of a sealing membrane. Suitable adhesives in this context are, in particular, pressure-sensitive or hotmelt adhesives.

In the case of factory-applied pressure-sensitive adhesives, there is the drawback that a protective film (also referred to as “release liner”) is required, in order to protect the pressure-sensitive adhesive during transport. This protective film has to be pulled off prior to bonding, leads to an increased requirement for material and has to be disposed of after use, which is associated with additional costs.

The application of a pressure-sensitive adhesive at the construction site does avoid this problem, but is itself associated with the drawbacks that an additional working step is required and the amount of adhesive used by personnel can be controlled only with difficulty. A further drawback of pressure-sensitive adhesives is that the sheet has to be moved once again (i.e. rolled up or folded) after alignment. Finally, the adhesion forces of known pressure-sensitive adhesives are also frequently much lower than those of hotmelt adhesives used for this purpose.

Hotmelt adhesives can be applied in a simple manner to roofing membranes at the factory and are non-tacky under normal processing conditions for the roofing membranes, and so there is no requirement to provide a pre-applied hotmelt adhesive layer with a protective film. However, it is disadvantageous here that a hotmelt adhesive has to be melted prior to bonding, for which a gas burner is frequently used nowadays on construction sites. This means an increased hazard potential, especially since other combustible materials are frequently also present on construction sites, and these can be ignited on contact with open flames. Moreover, in the case of activation of hotmelt adhesives on watertight membranes which themselves consist of combustible materials, there is the risk of melting or burning of the membrane.

Finally, the application of a membrane equipped with a hotmelt adhesive with open flames also requires another movement of the sheet after the alignment, since the flame are held against the hotmelt adhesive layer and the latter then has to be contacted with the substrate on which the membrane is to be secured.

A process in which this problem is avoided is known from another context, namely for the application and securing of carpets on substrates beneath. Subsequently, a hotmelt adhesive layer located under a carpet is heated and liquefied by applying a hot surface (for example in the form of an iron) on the carpet, and, after the adhesive has cooled down, a bond is thus formed between the carpet and the carrier substrate.

In the case of materials for waterproofing, however, such a process generally cannot be utilized because the substrate layer is heated first of all through the hot surface. Since watertight membranes generally have thicknesses of several millimeters and consist of materials which can be damaged at relatively high temperatures, the application of the process described would make the process very energy-intensive. Moreover, hotmelt adhesives having a significantly lower melting point than the plastics substrate would be required, in order to avoid damage to the substrate layer.

US 2006/157477 proposes, as a further development for the activation of kraft paper-based adhesive tapes coated with hotmelt adhesives, heating with the aid of induction. This involves converting an electromagnetic field to heat with the aid of a conductive metal layer and hence heating and liquefying a hotmelt adhesive applied to the metal layer.

US 2009/0191387 relates to a circuit arrangement comprising a dielectric layer and a conductive layer, with an adhesive layer arranged between the dielectric layer and the conductive layer, wherein the adhesive comprises poly(arylene) ether.

WO 2011/102170 A1 relates to thermally conductive pressure-sensitive adhesives comprising, inter alia, expanded graphite powder and alumina.

In the field of waterproofing materials, there is a need for composite films having a hotmelt adhesive coating which can be heated and thus activated without the application of open flames. Furthermore, there is a need for composite films in which any hotmelt adhesive layer present, if at all possible, can also be activated and liquefied from the opposite side of the composite film from the hotmelt adhesive layer. Such a composite film would avoid the need to directly treat the hotmelt adhesive layer with open flames and then to lay it onto the substrate, and enable the composite film first to be placed with an exact fit onto the substrate to be waterproofed and then to be secured on the substrate. This would make it much easier than has been possible to date to avoid faults and gaps.

The present invention is concerned with these problems.

### DESCRIPTION OF THE INVENTION

A first aspect of the present invention relates to a composite film comprising a water-impermeable substrate layer composed of plastic with a coating, comprising a flat element composed of an electrically conductive material and a hotmelt adhesive.

A “flat” element is understood to mean an element having a length and width greater at least by a factor of 50, preferably at least by a factor of 100 and especially preferably at least by a factor of 1000 than its thickness (0.1-1000 mm). Examples of particularly suitable flat elements composed of an electrically conductive material are, for example, metal foils or metal meshes or grids or weaves, in which ring currents are induced on contact with an electromagnetic field. These ring currents then lead to rapid heating of the metal. However, it is also conceivable that the conductive material is based on carbon fibers and is in the form, for example, of a carbon fiber grid.

The flat element composed of an electrically conductive material may, in relation to its length and width, have the same dimensions as the composite film, but it is also possible that the flat element, in relation to its length and width, is smaller than the composite film. It is likewise possible that the composite film has a plurality of flat elements composed of one electrically conductive material or different electrically conductive materials that may be in contact with one another or spaced apart from one another.

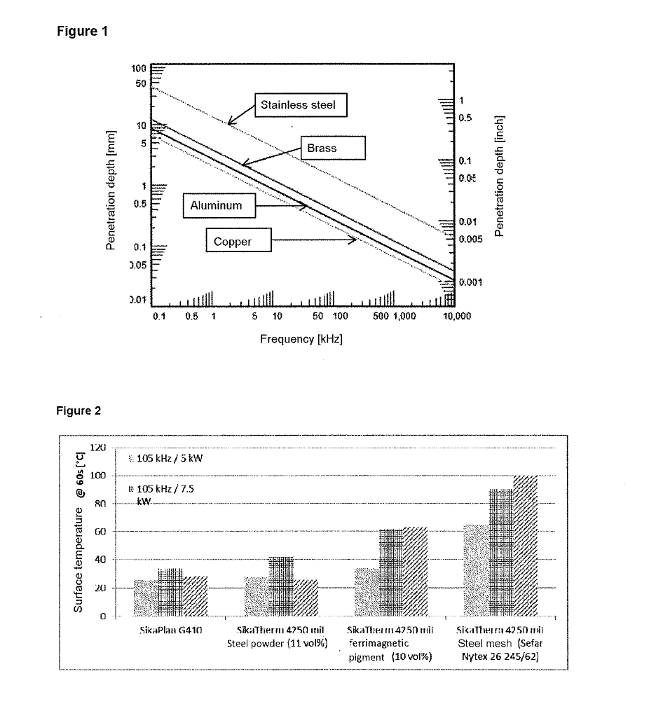

If the electrically conductive material is a metal or metal alloy, it is preferable when it is selected from iron, for example in the form of steel, aluminum, brass or copper. This element need not necessarily consist exclusively of these metals, but may also contain customary further metal or non-metal constituents, provided that these do not significantly impair the electrical conductivity of the material. In this regard, it is well known to the person skilled in the art that the penetration depth of an electromagnetic field decreases with increasing conductivity of the metal, such that, for example, copper at the same frequency has a significantly lower penetration depth than stainless steel (cf. FIG. 1).

In the context of the present invention, in particular, metal foils composed of aluminum and steel/iron and metal meshes or weaves composed of steel/iron have been found to be particularly appropriate. Aluminum in foil form can be handled and processed with relative ease, and so it is possible to produce aluminum-coated foils relatively easily. Iron, by contrast, has the advantage of lower costs of the raw material and, especially in the form of iron meshes or weaves or grids, in combination with hotmelt adhesives, still shows very good processing and use properties.

Moreover, it is possible in the case of flat elements in the form of meshes, weaves or grids to embed them into the hotmelt adhesive layer, such that there is no requirement for any additional lamination, for example of a metal foil onto the substrate layer, for which an additional adhesive may be required. Embedding additionally has the advantage that there is no direct contact with the water-impermeable substrate layer, and so the risk of damage to this layer on melting of the hotmelt adhesive can be reduced further.

Suitable mesh sizes for weaves or meshes or grids, especially based on metals, in connection with the present invention have been found to be a range from about 10 to about 2000 μm, preferably about 50 to about 1500 μm, and more preferably about 100 μm to about 1200 μm.

In the course of the studies underlying the present invention, it was found that nonconductive materials, for example ferri- or ferromagnetic iron pigments, couple only inadequately to an alternating magnetic field, and so it was not possible to achieve sufficient heating rates with such powders in hotmelt adhesive layers of thickness up to 2 mm. This is a problem especially in the case of substrate layers composed of plastic, because the substrate layer is also significantly heated by heat transfer in the case of an only very gradually heated hotmelt adhesive, which can lead to damage to the substrate layer.

The flat element composed of an electrically conductive material preferably has a thickness in the range from 1 to 500 μm, and more preferably 50 to 100 μm.

With regard to the water-impermeable substrate layer composed of plastic, there are no particular demands on the composite film of the invention, but it is appropriate to use substrate layers composed of polyvinyl chloride (PVC), ethylene-vinyl acetate (EVA) or TPO (thermoplastic olefins), for example polypropylene-polyethylene copolymers. The thickness of the water-impermeable substrate layer is preferably in the range from 0.1 to 10 mm, more preferably 0.5 to 5 mm and more preferably 1 to 3 mm.

Nor are there any particular demands on the hotmelt adhesive, but it may be appropriate when the hotmelt adhesive used is a hotmelt adhesive based on ethylene-vinyl acetate (i.e. with ethylene-vinyl acetate as an essential functional constituent). In addition, it is advantageous when the hotmelt adhesive has a softening point below the softening point of the plastic of the substrate layer, and especially at least about 10 kelvin below the softening point of the plastic of the substrate layer, since the membrane can otherwise be damaged during heating.

The softening point is preferably measured here by the ring & ball method, for example in accordance with DIN EN 1238.

The thickness of the hotmelt adhesive applied is preferably in the range from about 0.01 to 5 mm, preferably about 0.05 to 2 mm, and most preferably in the range from about 0.1 to 1 mm.

The hotmelt adhesive is especially present in the composite film in such a way that it forms an outer surface of the composite film. If the hotmelt adhesive used is a composition comprising constituents, for example in the form of plasticizers, which can migrate into the water-impermeable substrate layer and impair its functionality, it may be advisable to apply a barrier layer between the coating composed of the hotmelt adhesive and the water-impermeable substrate layer.

In addition, it is preferable when the coating comprising a hotmelt adhesive and a flat element composed of an electrically conductive material has a thickness of about 0.015 to 5.5 mm, preferably about 0.05 to 2 mm, and on especially preferably about 0.1 to 1.1 mm.

In respect of the water-impermeable substrate layer, finally, it is preferable when it takes the form of a watertight membrane, preferably a watertight roofing membrane. Accordingly, the membrane should have a shape and dimensions as normally present in the case of watertight membranes or roofing membranes.

A second aspect of the present invention relates to a method of applying a composite film as outlined above to a substrate, which is characterized in that

i) the composite film is placed onto the substrate,
ii) the composite film is exposed to an alternating magnetic field until the hotmelt adhesive has softened or melted, and
iii) the hotmelt adhesive is cooled down below its softening point to form a bond with the substrate.

Within the method described, the interaction of the alternating magnetic field with the flat element composed of an electrically conductive material leads to heating of the material; this is also referred to as inductive heating. In this process, an alternating magnetic field which is generated by an inductor produces a current in the electrically conductive material, which is converted to heat because of the electrical resistivity of the material. The result of this is that materials having higher electrical resistivity are heated more quickly under the same induction conditions. Thus, the efficiency of such materials is also higher on inductive heating. The frequency of the alternating magnetic field has a significant influence on the penetration depth into the material, and on the minimum layer thickness of the conductive material which effectively couples to the magnetic field employed. The penetration depth decreases with increasing conductivity (see FIG. 1).

Within the method, better bonding outcomes are obtained when the composite film is subjected to pressure during the cooling, for example by applying pressure to it, until the bond with a substrate beneath has formed, and preferably until the hotmelt adhesive has cooled down sufficiently below its softening point and hence a firm bond has formed.

In relation to the frequency of the alternating magnetic field, there are no significant requirements, with the proviso that the alternating magnetic field should have a frequency in the range from about 1 to about 10 000 kHz. In the context of the present invention, however, it has in particular been found that frequencies in the range from 50 to 400 kHz and preferably 80 to 250 kHz lead to short heating times and suitable heating rates.

In addition, it is preferable when the inductor that produces the alternating magnetic field is operated with a power from about 0.05 to 20 kW, preferably 0.1 to 10 kW, and more preferably 0.15 to 5 kW. For corresponding powers, given thicknesses of a flat element composed of metal of about 30 μm, it was possible to measure sufficient heating rates and rapid heating times to a temperature of about 100° C. This is advantageous in order to achieve a processing time comparable to conventional methods in which the hotmelt adhesive is activated by contact with flames.

It will be apparent to the person skilled in the art that the parameters of frequency, power and surface area of the inductor that produces the alternating magnetic field interact with one another and hence are crucial in determining the heating rate of the hotmelt adhesive. The parameters mentioned, i.e. the power, frequency and surface area of the inductor that produces the alternating magnetic field are therefore appropriately matched to one another such that the hotmelt adhesive is heated at a rate of at least 16 K/s, preferably at least 20 K/s. The person skilled in the art will be capable without difficulty of undertaking a corresponding matching of the parameters mentioned.

In the context of the present invention, it is further preferable when the alternating magnetic field is provided using a portable generator, since this ensures sufficient mobility of the inductor especially in the case of application of the composite films to roof surfaces. One example of an inductor suitable in the context of the present invention, and a viable geometry for the inductor surface, is described, for example, in US 2006/157477 A1, the disclosure content of which shall hereby be incorporated by reference.

Since roofing membranes are large-area applications, it is further preferable when the generator that produces the alternating magnetic field has a surface area of the inductor of at least 1000 mm². Preference is given to a surface area of the inductor in the range from 6000 to 200 000 mm², and more preferably 50 000 to 150 000 mm².

A further aspect of the present invention is concerned with the use of an alternating magnetic field for activating a hotmelt adhesive and for bonding of composite films as described above to a substrate. Preferably, the substrate to which the composite film is to be bonded is a concrete substrate, a thermal insulation with any protective layer or a gypsum or fiberboard.

The present invention is elucidated in detail hereinafter by a few examples, but these are not intended to have any limiting effect on the present invention.

### Example 1

A standard roofing membrane (Sikaplan G410-12EL) was coated with a hotmelt adhesive of the Sikatherm 4250 type in a layer thickness of 200 μm, this layer including, in embedded form, a steel powder (11% by volume), a ferrimagnetic iron pigment (brown Fe₃O₄; 10% by volume) and a metal weave of the Sefar Nytex 26-245/62 type. The membrane thus coated was treated with an alternating electromagnetic field under the conditions of (i) 105 kHz/5 kW, (ii) 105 kHz/7.5 kW and (iii) 160 kHz/4.5 kW for 60 seconds (steel powder & iron pigment) or 20 seconds (metal weave). The results of these studies are shown in FIG. 2. The temperatures reported were determined with the aid of a conventional thermocouple (K type) immediately after the electromagnetic field had been switched off.

In the studies, it was found that the sample comprising the metal weave had the highest temperature after the treatment. By contrast, the composite films comprising ferrimagnetic iron powder and ferromagnetic iron pigments had only inadequate heating to no heating at all.

What was surprising here was that a content of 10% by volume of metal powder did not lead to a significant increase in temperature compared to uncoated Sikaplan G410-12EL membranes. Accordingly, a proportion of 10% by volume of metal powder is insufficient to form a coherent and hence conductive network.

### Example 2

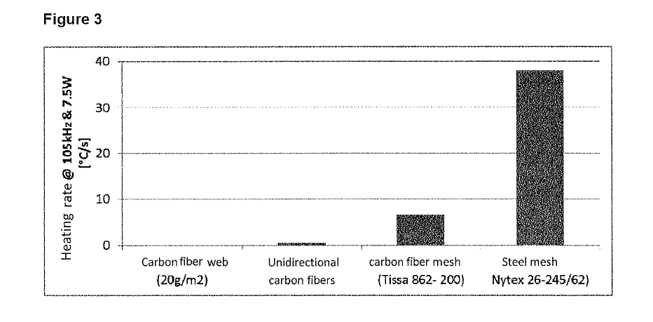

Instead of a metal weave of the Sefar Nytex 26-245/62 type, in a further study, various carbon fiber-based materials were studied. For this purpose, unidirectional carbon fibers, a carbon fiber weave of the Tissa 862-200 type and a carbon fiber web were used, which were embedded into the adhesive layer like the metal weave. The composite films thus produced were treated an alternating magnetic field having a frequency of 105 kHz with a power of 7.5 kW, and the heating rate of the adhesive layers was determined. The results of these measurements are shown in FIG. 3.

It was found that heat could be generated only in the case of the samples with closed fiber circuits (i.e. in the case of the sample comprising carbon fiber weave or iron weave). The sample comprising carbon fiber weave heated up at an acceptable rate of 6.5° C./s, whereas it was actually possible to determine a heating rate of about 40° C./s in the case of the sample comprising iron weave. By contrast, the samples comprising carbon fiber web or an addition of unidirectional carbon fibers did not exhibit any significant heating.

### Example 3

A 200 μm-thick coating of a hotmelt adhesive based on EVA (Sarnacoll 2121) was applied to a membrane of the Sikaplan G14-12EL type (based on PVC; thickness about 1.2 mm) coated with a steel weave or an aluminum foil. In the case of the steel weave, the layer thickness refers to the thickness of the individual weave strands (see table 1). The composite films thus obtained were treated with an alternating electromagnetic field having the frequency and power specified in table 1 below. In the course of this, the time within which the hotmelt adhesive was heated from 25° C. to 100° C. and the heating rate of the hotmelt adhesive were determined. The inductor used for the heating had a surface area of 6900 mm².

TABLE 1

| Example | | 1 | 2 | 3 | 4 | 5 | 6 | 7 |
|---|---|---|---|---|---|---|---|---|
| Adhesive | | | | | Hotmelt | | | |
| Type | | | | | EVA | | | |
| Layer thickness | [mm] | | | | 0.2 | | | |
| Membrane | | | | | Sikaplan G14-12EL | | | |
| Type | | | | | PVC roofing | | | |
| | | | | | membrane | | | |
| Thickness | | | | | 1.2 mm | | | |
| Inductor area | [mm²] | | | | 6900 | | | |
| Electrical conductor | | Stainless steel | | | | | Aluminum | |
| Type | | | about 30 μm | | about 125 μm | | about 30 μm | |
| Layer thickness | | | | | | | | |
| Induction parameters | | | | | | | | |
| Frequency | [kHz] | 100 | 100 | 225 | 100 | 100 | 100 | 225 |
| Power | [kW] | 1.5 | 1 | 1 | 1.5 | 0.2 | 0.15 | 0.2 |
| Heating time | | | | | | | | |
| 25-100° C. | [s] | 5 | 9 | 3 | 2 | 6 | 10 | 3 |
| Heating rate | [K/s] | 15.0 | 8.3 | 25.0 | 37.5 | 12.5 | 7.5 | 25.0 |

The comparison of the samples 1, 2 or 3 with the samples 5, 6 or 7 shows that the power required to heat up the adhesive in the case of stainless steel is higher by a factor of 5 to 6 compared to aluminum. This corresponds roughly to the difference in the penetration depth of the electrical field for the two materials. Examples 3 and 7 additionally show that the increase in the frequency leads to a reduction in the heating time for the two electrically conductive materials studied and hence to an increase in the heating rate. It is apparent from example 4 that a thicker layer of the electrically conductive material (iron) with the same frequency likewise leads to a reduction in the heating time. Both observations (i.e. the influence of the frequency and layer thickness of the conductor) are in accordance with the penetration depth of the electromagnetic field into the electrical conductor. The elevated frequency bundles the output power released in a thinner layer, whereas the thicker layer absorbs an increased degree of the output power released. The efficiency of the inductive heating can thus be enhanced by the increase in the layer thickness of the flat element composed of an electrically conductive material.

1. A composite film comprising a water-impermeable substrate layer composed of plastic with a coating comprising a flat element composed of an electrically conductive material and a hotmelt adhesive.

2. The composite film as claimed in claim 1, wherein the flat element composed of an electrically conductive material takes the form of a metal foil or metal mesh.

3. The composite film as claimed in claim 1, wherein the flat element composed of an electrically conductive material consists of a metal or metal alloy.

4. The composite film as claimed in claim 2, wherein the flat element composed of an electrically conductive material takes the form of a metal weave embedded into a hotmelt adhesive.

5. The composite film as claimed in claim 1, wherein the flat element composed of an electrically conductive material has a thickness in the range from 1 to 500 μm.

6. The composite film as claimed in claim 1, wherein the water-impermeable substrate layer is based on a thermoplastic polyolefin or PVC.

7. The composite film as claimed in claim 1, wherein hotmelt adhesive is based on ethylene-vinyl acetate.

8. The composite film as claimed in claim 1, wherein the coating comprising a hotmelt adhesive and a flat element composed of an electrically conductive material has a thickness in the range from 0.05 to 2 mm.

9. The composite film as claimed in claim 1, wherein the hotmelt adhesive forms an outer surface of the composite film.

10. The composite film as claimed in claim 1, wherein the substrate layer takes the form of a watertight membrane.

11. A method of applying a composite film as claimed in claim 1 to a substrate, wherein
i) the composite film is placed onto the substrate,
ii) the composite film is exposed to an alternating magnetic field until the hotmelt adhesive has softened or melted, and
iii) the hotmelt adhesive is cooled down below its softening point to form a bond with the substrate.

12. The method as claimed in claim 11, wherein composite film is subjected to pressure during the cooling until the bond has formed.

13. The method as claimed in claim 11, wherein the alternating magnetic field has a frequency in the range from 50 to 400 kHz.

14. The method as claimed in claim 11, wherein the inductor that produces the alternating magnetic field is operated with a power from 0.05 to 20 kW.

15. The method as claimed in claim 11, wherein the power, frequency and surface area of the inductor that produces the alternating magnetic field are matched to one another such that the hotmelt adhesive is heated at a rate of at least 16K/s.

16. The method as claimed in claim 11, wherein the alternating magnetic field is provided using a mobile generator.

17. The method as claimed in claim 11, wherein the inductor that produces the alternating magnetic field has a surface area of at least 1000 mm².

18. A method comprising activating a hotmelt adhesive and bonding of composite films as claimed in claim 1 to a substrate by application of an alternating, magnetic field.
